(19) United States
(12) Patent Application Publication
(10) Pub. No.: US 2012/0290490 A1
(43) Pub. Date: Nov. 15, 2012

(54) SYSTEM AND METHOD FOR DISPLAYING PRODUCT CERTIFICATION

(76) Inventors: Michael Young, Toronto (CA); Stephen Van Egmond, Toronto (CA)

(21) Appl. No.: 13/104,175

(22) Filed: May 10, 2011

(51) Int. Cl. G06Q 99/00

(52) U.S. Cl. 705/317

(57) ABSTRACT

A product certification code is provided. The product certification code is associated with a target product and comprises a uniform resource identifier (URI). The URI is configured to identify certification information at a certification data provider, which is configured to maintain the certification information about the target product. A method for retrieving the certification information from the certification data provider is also provided. Further, the certification data provider and a method for providing the certification information from the certification data provider are also provided.

The present invention relates generally to product certification and specifically to a system and method for displaying product certification information to an interested party.

### BACKGROUND

A certification mark is a visible sign that indicates a product or service meets established standards for safety and quality. The certification mark verifies that organizations have the people, expertise and equipment to make the product or do the job as required by the standards set for that particular industry.

For many products and services, certification is a legal requirement. However, even when certification is not legally required, it may make good business sense. When it comes to demonstrating safety and quality, a certification mark may improve the products' or services' chances for success in a competitive marketplace.

Generally speaking, certification is achieved as follows. A prototype of the product is tested to ensure it meets applicable standards. If the prototype is determined to meet the requirements of the applicable standard, the certification body authorizes use of their product certification mark. Production facilities for the product are inspected regularly to ensure products continue to comply with standards

Therefore, an accredited certification body's stamp of approval could a valuable marketing tool. Knowing that the product or service has been reviewed by an independent organization and found to meet the applicable standards is a measure of confidence that can be trusted by consumers.

However, the consumer has to trust that the product certification was actually obtained and, if it was, that it has been maintained. For example, unscrupulous companies may mark their product with a certification mark even if it has not been certified. As another example, companies may have their certification mark revoked for a product but products already in the marketplace will still bare the certification mark.

Accordingly, it is desirable to be able to display product certification information to an interested third party, such as a consumer, in such a way that obviates or mitigates at least some of the disadvantages discussed above.

### SUMMARY

In accordance with an aspect of the present invention there is provided a product certification code associated with a target product, the product certification code comprising a uniform resource identifier configured to identify certification information at a certification data provider, the certification data provider configured to maintain the certification information about the target product.

In accordance with a further aspect of the present invention there is provided a method, to be implemented at a certification data provider, for retrieving certification information associated with a target product, the target product including a product certification code comprising a uniform resource identifier configured to identify the certification data provider, the method comprising the steps of: receiving a request for the certification information, the request including at least a portion of the uniform resource identifier; and transmitting at least a portion of the certification information in response to the request.

In accordance with yet a further aspect of the present invention there is provided a method for retrieving certification information from a certification data provider, the certification information associated with a target product, the method comprising the steps of: obtaining a uniform resource identifier from a product certification code associated with the target product; transmitting a request to the certification data provider for the certification information, the request including at least a portion of the uniform resource identifier; and receiving at least a portion of the certification information from the certification data provider.

In accordance with yet a further aspect of the present invention there is provided a certification data provider configured to receive certification information from one or more certification authorities regarding at least one target product, the certification data provider comprising: memory for storing the certification information; and computer-readable instructions; a processor operable to implement the computer readable instructions for: generating a product certification code comprising a uniform resource identifier; receiving a request for the certification information, the request including at least the uniform resource identifier; and providing at least a portion of the certification information to an interested third party in response to the request.

### BRIEF DESCRIPTION OF THE DRAWINGS

Embodiments of the present invention will now be described by way of example only with reference to the following drawings in which:

FIG. 1 is block diagram illustrating a network infrastructure; and

FIG. 2 is flowchart illustrating steps taken to obtain a product certification code.

### DETAILED DESCRIPTION OF THE PREFERRED EMBODIMENT

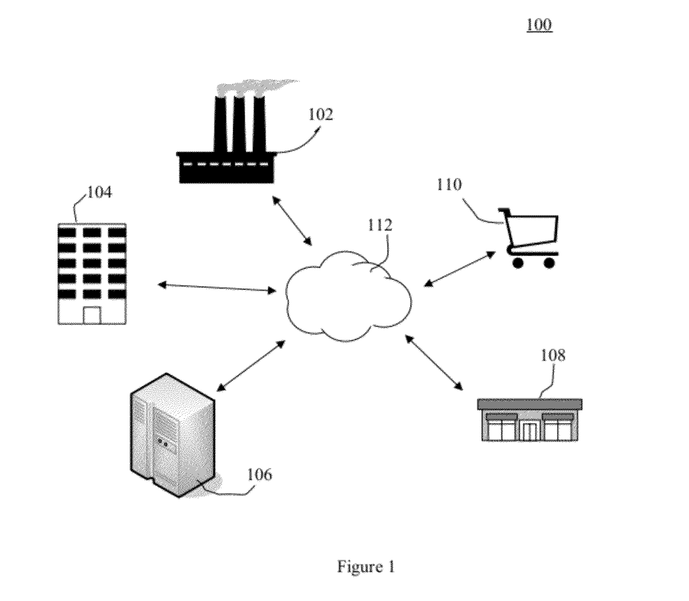

For convenience like numerals in the description refer to like structures in the drawings. In a first embodiment, a verification system for providing third party verification of a certification mark is described. Referring to FIG. 1, the verification system is illustrated generally by numeral 100. The verification system 100 includes a provider 102, a certification authority 104, a certification data provider 106, a reseller 108, a consumer 110 and a communication network 112.

Each of the provider 102, certification authority 104, certification data provider 106, reseller 108 and consumer 110 may employ a computer, or plurality of computers connected via a network, as is known in the art. The computer, or computers, can be used to manage resources, provide services, facilitate communication (both internally and externally) and the like. Also, as known, the computers may come in a variety of different forms, including both wired and wireless forms, such as desktop computers, notebook computers, handheld computers, portable digital assistants, smart phones, tablets and the like. The computers can be configured to communicate with other computers and web servers via the communication network 112.

The provider 102 represents a provider of a product or service. In the present embodiment, the provider 102 is a manufacturer that manufactures physical products. However, in other embodiments, the provider 102 may also be a service provider such as an infrastructure provider (i.e. electronic, water or power), professional service provider, (i.e. health, legal, inspection services provider etc.) or other type of service provider that may benefit from certifying the services they provide. The following description will refer specifically to products for ease of explanation only. It will be appreciated that services may be substituted for or added to the products.

The certification authority 104 is a certification body such as a standards body or corresponding agent registers who are authorized to approve certification requests from the providers 102. The actual process of approving the certification request is beyond the scope of the present invention and is, therefore, not described in detail.

The certification data provider 106 provides a centralized data store for the providers 102 and associated products that have been certified by the certification authority 104. The certification data provider 106 and the certification authority 104 are configured to communicate securely to instill confidence that information received by the certification data provider 106 is actually transmitted by the certification authority 104. Accordingly, the certification data provider 106 and certification authority 104 use a combination of encryption and digital signatures to transfer the information. The methods used to encrypt and sign the information can be any one of a number of known or propriety schemes chosen by the data provider 106 and certification authority 104, as will be appreciated by a person skilled in the art.

Further, as will be described, the certification data provider 106 creates a product certification code for each different product. The product certification code is a tangible code that can be printed or otherwise displayed on the product itself, its packaging, instruction manual, warranty or other printed material available with the product. The product certification code can also be pictured on a web-page associated with the product, whether the product is a physical product or service. The product certification code can then be used to access information regarding the associated product using a predefined protocol, application programming interface (API), web API or web service.

The reseller 108 is a vendor or store, either wholesale or retail, that sells or otherwise distributes the product. The consumer 110 is a person that purchases or otherwise obtains the product from the reseller 108.

The communication network 112 may include several components such as a wireless network, a relay, a corporate server and/or a mobile data server for relaying data between the computers. Furthermore, the communication network 112 may include a wide area network (WAN) and/or a local area network (LAN). This includes, for example, public networks such as the Public Switched Telephone Network (PSTN) and the Internet, as well as private networks or Intranets. The actual configuration of the communication network 112 may vary, depending on the implementation, as will be appreciated by a person of ordinary skill in the art.

Therefore, as will be described below, the provider 102 can obtain certification for a product from one or more certification authorities 104. Once the product is certified, the provider 102 obtains the product certification code. The product certification code is placed on the product and/or the product's packaging, or otherwise associated with the product. The product certification code can then be used by one or both of the reseller 108 or the consumer 110 to contact the certification data provider 106 and verify that the product is, in fact, certified. Thus, the providers 102 can communicate certification received from a number of different certification authorities via a single item, the product certification code, rather than having to list them all. Further, any changes made to the certification can be propagated to the reseller 108 or the consumer 110 without requiring changes to the product or packaging.

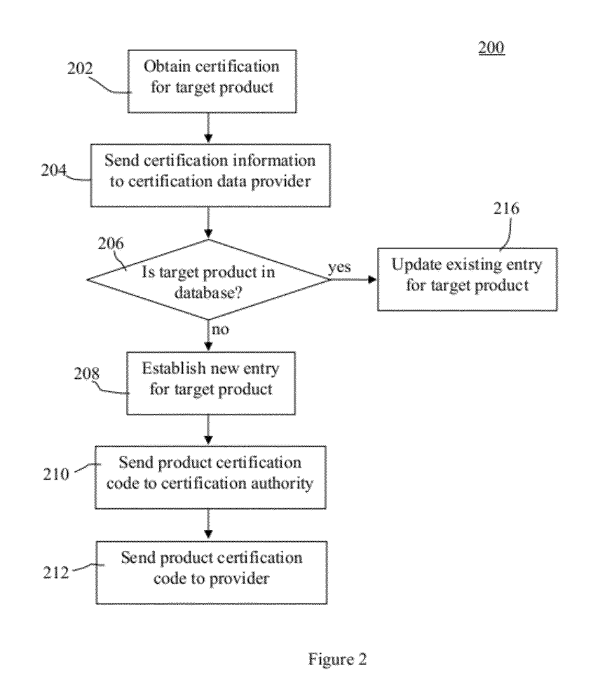

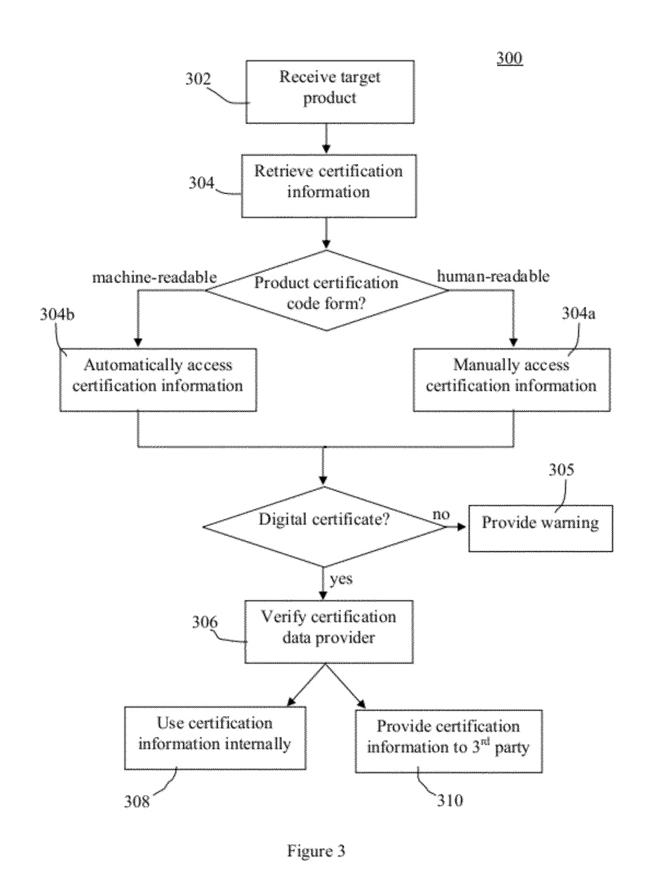

Referring to FIG. 2, a flow chart illustrating steps taken to obtain the product certification code is illustrated generally by numeral 200. At step 202, the provider 102 obtains certification of a target product. In the present embodiment, the provider 102 submits a certification request to a desired certification authority or authorities and obtains certification if the target product meets the criteria set by the certification authority or authorities for each desired certification mark.

At step 204, the certification authority 104 communicates certification information to the certification data provider 106 regarding the certification obtained by the provider 102. The certification information includes information sufficient to identify the target product and may include information about the provider 102, the target product and the certification or certifications obtained. Information about the provider 102 may include its name, address, contact information and the like. Information about the target product may include its name, a product identifier such as a universal product code (UPC) for example, a product description and the like. Information about each certification obtained may include its name, a certification mark, a certification description and the like. Depending on the implementation, other information may also be provided.

At step 206 the certification data provider 106 determines whether or not the target product has already been entered in its database. If the target product has not been entered in its database, the certification data provider 106 continues at step 208.

At step 208, the certification data provider 106 establishes a new entry for the target product, enters the certification information and generates the product certification code in the form of a product certification code. In the present embodiment, the product certification code comprises a data matrix code, such as a quick response (QR) code for example.

The data matrix code generated by the certification data provider 106 includes a uniform resource identifier (URI) that can be used to access the certification information, either in part or in its entirety. For example the URI can include a certification information locator such as a uniform resource locator (URL). As another example, the URI can include a certification information identifier such as uniform resource name (URN). As another example, the URI may include both the certification information locator and the certification information identifier.

The data matrix code may further include a digital signature of the certification data provider 106. In the present embodiment, the digital signature is created by application of a private key of the certification data provider 106 to the URI. The digital signature is then appended to the URI, separated by a delimiting character. Thus, for example, the URI can be a URL such as http://www.ecolabelindex.com/my/1/. Application of a public key to the URL will result in an encoded URI, represented by a character string such as 4At6b812jv2117. It should be noted that this encoded URI is a random character string for illustrative purposes only. Further, in this example, the delimiting character is the # symbol, often referred to as a hash, or pound, symbol. In this example, the hash symbol is used because characters after it are not processed by a web browser. Accordingly, the URI/digital signature combination becomes:

http://www.ecolabelindex.com/my/1/#4At6b812jv2117gj

In an alternative embodiment, the digital signature may be stored apart from the URI, rather than appended to it. It will be appreciated by a person of ordinary skill in the art that other known or proprietary methods can be used to provide a digital signature for the certification data provider 106.

Optionally, the certification information locator may also be included as part of the product certification code, in addition to the data matrix code. This option provides the product certification code with a human-readable form, the certification information locator, in addition to a machine-readable form, the data matrix code.

At step 210, the product certification code is transmitted to the certification authority 104. At step 212, the certification authority 104 transmits the product certification code to the provider 102. The provider 102 can then mark the target product with the product certification code and ships units of the target product for sale.

Returning once again to step 206, if the target product has been entered in the database of the certification data provider 106, it continues at step 216. At step 216 the certification data provider 106 updates the certification information in its database for the target product with the new certification information received from the certification authority 104. The new certification information may be a new certification mark for the target product, a change in an existing certification, a removal or a certification mark, or any combination thereof. A product certification code does need to be generated because one already exists for the target product.

Accordingly, it will be appreciated that the target product is with the product certification code. The product certification code can represent multiple certification marks for the target product. Further, the product certification code provides a link to the certification data provider 106, which maintains an up-to-date record of the certification mark or certification marks for the target product.

The product certification code can be used by one or both of the reseller 108 or the consumer 110. Referring to FIG. 3, a flow chart illustrating steps taken to retrieve the certification information for the target product is illustrated generally by numeral 300. For example, at step 302, the reseller 108 receives the target product including the product certification code from the provider 102. If the product certification code is not visibly located on the target product as received from the provider 102, the provider may also provide a copy of the certification code along with the target product.

At step 304, the reseller 108 can retrieve the certification information relating to the target product using the product certification code. If the product certification code includes the certification information locator in human-readable form, at step 304a, the reseller 108 manually accesses the certification information by navigating to the location identified by the certification information locator. For example, if the certification information locator is a URL, the reseller 108 can navigate a web browser to a web site identified by the URL. The web site provides the reseller 108 with certification information pertaining to the target product.

If the product certification code includes the certification information locator in machine-readable form, such as the data matrix code, at step 304b, the reseller 108 automatically accesses the certification information using a data matrix/barcode scanner to scan and interpret the data matrix code. The data matrix/barcode scanner can be a dedicated scanner or an imager, such as a camera, that captures the image and then processes the image using software, as is known in the art. The data matrix/barcode scanner retrieves the URI from the data matrix code and can use it in a number of different ways.

In a first example, the computer at the reseller 108 parses the URI for the URL and presents it to the reseller 108. The reseller 108 can then manually use the URL to access the web site, as described above.

In a second example, the computer at the reseller 108 parses the URI for the URL, automatically launches the web browser, and directs it to the web site identified by the URL.

In a third example, the computer at the reseller 108 executes a certification application on behalf of the certification data provider 106. The certification application is configured to parse the URI for one or both of the URL or the URN. The certification application can contact use the URL to access the web site, retrieve the certification information and present it on a user interface. Alternatively, the certification application can be programmed to include general location information for the certification data provider 106. In this case, the certification application can make use of the API, web API or web service provided by the certification data provider 106, transmit a request including the URN, receive the certification information and present it on a user interface.

The reseller 108 may use any one of the above described ways for accessing the certification information from the certification data provider 106, manually or automatically, either alone or in combination, depending on the implementation.

If it is detected that there is no digital signature, then at step 305 the reseller 108 is present with a warning such as a pop-up window or other notification. If the product certification code includes a digital signature, then at step 306 the reseller 108 verifies the authenticity of the certification data provider 106. The reseller 108 can use a public key provided by the certification data provider 106, or an agent thereof, to authenticate the product certification code, thereby instilling confidence that it was, in fact, issued by the certification data provider 106. The public key may be made publicly available or may be made available on a subscription basis only.

Continuing the previous example, the URI/digital signature combination is

http://www.ecolabelindex.com/my/1/#4At6b812jv2117gj

The reseller 108 parses the URI for the delimiter and retrieves the encoded URI. The reseller 108 uses the public key to generate a decoded URI by decrypting the encoded URI. The decoded URI is compared against the portion of the URI that precedes the hash symbol. If the comparison is a match then the digital signature is validated. If the comparison is not a match, the signature is invalid and the reseller 108 is advised accordingly. Depending on the implementation this may include anything from a warning to prohibiting the reseller 108 from continuing further. Accordingly, in some implementations, step 306 may be performed prior to accessing the certification information at steps 304a and 304b.

The certification information retrieved by the reseller 108 may be for internal use, external user, or both. For example, at step 308 the reseller 108 may want, or need, to verify that the target product meets a predefined standard before being able to sell it to the consumers 110. As another example, at step 310 the reseller 108 may provide computer terminals that can be used by the consumers 110 to determine the certification information based on the product certification code.

The consumer 110 can also determine the certification information relating to the target product using the product certification code. The examples described with reference to the reseller 108 can likewise apply to the consumer 110. For example, if the product certification code includes a human-readable URL, the consumer 110 can simply enter the URL into a browser using the consumer's computer. Further, many computers include a camera which can be used to capture the product certification code. Software executing on the computer can be used to interpret the product certification code and use it as described with reference to the reseller 108 in order to retrieve the certification information.

Thus it can be seen that the product certification code as described allows an interested third party, such as the reseller 108 or the consumer 110, to determine what certification marks the target product obtained. Moreover, the product certification code provides a single resource for the interested third party to review multiple certifications for the target product. The authenticity of the certification information can further be verified using a digital signature, or other authentication means. Yet further, any changes to the certification information can be propagated to the interested third party without requiring a change to the way the target product is marked, thus requiring no change to existing inventory. Thus, the interested third party receives up-to-date information about the certification information and can easily be made aware of any new or revoked certifications.

In the embodiments described above, the certification data provider 106 is a consolidated certification data provider 106 that acts a single source for all certification authorities. In an alternative embodiment, the certification data provider 106 may be represented by plurality of different sources, either independent or representative agents, each of which each is configured to represent a plurality of different certification authorities. The structure of such a plurality of certification data providers 106 may be flat or it may be hierarchical. In the hierarchical structure, a each of the plurality of certification data providers 106 reports, either directly or indirectly to a top level certification data provider 106.

Yet further, in the embodiments described above, the product certification code is transmitted to the certification authority 104, which then transmits it to the provider 102. However, it will be appreciated that the product certification code can be transmitted directly from the certification data provider 106 to the provider 102.

Yet further, although the certification information locator is described with reference to a URL and the certification information identifier is described with reference to a URN, other known or proprietary locators and identifiers other than a URL or a URN can used.

Using the foregoing specification, the invention may be implemented as a machine, process or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “software” and “application” as used herein are intended to encompass a computer program existent (permanently, temporarily, or transitorily) on any computer-usable medium such as on any memory device or in any transmitting device.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processors including, for example, a CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Using the description provided herein, those skilled in the art will be readily able to combine software created as described with appropriate general purpose or special purpose computer hardware to create a computer system and/or computer subcomponents embodying the invention, and to create a computer system and/or computer subcomponents for carrying out the method of the invention.

Although preferred embodiments of the invention have been described herein, it will be understood by those skilled in the art that variations may be made thereto without departing from the spirit of the invention or the scope of the appended claims.

What is claimed is:

1. A product certification code associated with a target product, the product certification code comprising a uniform resource identifier (URI) configured to identify certification information at a certification data provider, the certification data provider configured to maintain the certification information about the target product.

2. The product certification code of claim 1, wherein the certification information include a plurality of certification marks obtained for the target product.

3. The product certification code of claim 1, wherein the uniform resource identifier includes at least one of a certification information locator or a certification information identifier.

4. The product certification code of claim 3, wherein the certification information locator identifies a location of certification data provider.

5. The product certification code of claim 1 further comprising a digital signature of the certification data provider.

6. The product certification code of claim 5, wherein the digital signature comprises an encoded URI, the encoded URI being generated by applying a private key associated with the certification data provider to the URI.

7. The product certification code of claim 6, wherein the encoded URI is appended to the URI with a delimiter placed there between.

8. A method, to be implemented at a certification data provider, for retrieving certification information associated with a target product, the target product including a product certification code comprising a uniform resource identifier configured to identify the certification data provider, the method comprising the steps of:
receiving a request for the certification information, the request including at least a portion of the uniform resource identifier; and
transmitting at least a portion of the certification information in response to the request.

9. The method of claim 8 comprising the further step of generating the product certification code and transmitting the product certification code to a provider to be associated with the target product.

10. The method of claim 8, wherein the certification information include a plurality of certification marks obtained for the target product.

11. The method of claim 8, wherein the uniform resource identifier includes at least one of a certification information locator or a certification information identifier.

12. The method of claim 8, wherein the portion of the certification information is transmitted to an interested third party.

13. The method of claim 12, wherein the portion of the certification information is transmitted to the interested third part as a web page to be interpreted by a web browser.

14. The method of claim 12, wherein the portion of the certification information is transmitted to the interested third party as data to be interpreted by a certification application.

15. The method of claim 12 comprising the further step of dynamically updating the certification information at the certification provider.

16. A method for retrieving certification information from a certification data provider, the certification information associated with a target product, the method comprising the steps of:
obtaining a uniform resource identifier (URI) from a product certification code associated with the target product;
transmitting a request to the certification data provider for the certification information, the request including at least a portion of the uniform resource identifier; and
receiving at least a portion of the certification information from the certification data provider.

17. The method of claim 16, wherein the certification information include a plurality of certification marks obtained for the target product.

18. The method of claim 16, wherein the uniform resource identifier includes at least one of a certification information locator or a certification information identifier.

19. The method of claim 16, wherein the portion of the certification information is received as a web page to be interpreted by a web browser.

20. The method of claim 16, wherein the portion of the certification information is received as data to be interpreted by a certification application.

21. The method of claim 16, wherein the URI includes a digital signature comprising an encoded URI, the method comprising the further steps of:
decoding the encoded URI by applying a public key associated with the certification data provider to the encoded URI; and
comparing the decoded URI with the URI for validating the digital signature.

22. The method of claim 21, wherein a warning is presented if the URI does not include a digital signature or if the digital signature is invalid.

23. A certification data provider configured to receive certification information from one or more certification authorities regarding at least one target product, the certification data provider comprising:
memory for storing
the certification information; and
computer-readable instructions;
a processor operable to implement the computer readable instructions for:
generating a product certification code comprising a uniform resource identifier;
receiving a request for the certification information, the request including at least the uniform resource identifier; and
providing at least a portion of the certification information to an interested third party in response to the request.
